(19) United States
(12) Patent Application Publication
(10) Pub. No.: US 2021/0360930 A1
(43) Pub. Date: Nov. 25, 2021

(54) Compositions and Methods for Controlling Pathogens in Livestock Production Operations

(71) Applicant: Locus IP Company, LLC, Solon, OH (US)

(72) Inventors: Sean FARMER, North Miami Beach, FL (US); Ken ALIBEK, Solon, OH (US)

(21) Appl. No.: 16/965,488

(22) PCT Filed: Sep. 26, 2019
(86) PCT No.: PCT/US2019/053180

§ 371 Date: Jul. 28, 2020

Related U.S. Application Data
(60) Provisional application No. 62/737,449, filed on Sep. 27, 2018.

(51) Int. Cl. A01N 63/22; A01N 63/32; A01N 25/18

(52) U.S. Cl. CPC A01N 63/22; A01P 1/00; A01N 25/18; A01N 63/32

(57) ABSTRACT

The subject invention provides disinfectant compositions and methods of using these compositions for controlling disease in livestock production operations. In one embodiment, a disinfectant composition is provided for controlling disease-causing pathogens in an animal feeding operation (AFO), such as a chicken coop or barn. In preferred embodiments, the composition comprises one or more beneficial microorganisms and/or growth by-products thereof, such as biosurfactants, and is applied inside an enclosure using thermal fogging.

### CROSS-REFERENCE TO RELATED APPLICATION

This application claims priority to U.S. Provisional Patent App. No. 62/737,449, filed Sep. 27, 2018, which is incorporated herein by reference in its entirety.

### BACKGROUND OF THE INVENTION

Animal Feeding Operations (AFOs), and the larger scale Concentrated Animal Feeding Operations (CAFOs), make up an ever-increasing source of the world's meat and dairy products. These massive factory farms have drastically increased the productive output of the agricultural industry over the past nearly one-hundred years. However, coupled with the benefits of AFOs are numerous shortcomings and potential hazards.

In particular, given the extremely close quarters in which livestock are contained in feeding operations, the rapid spread of pathogenic microorganisms between the environment and the animals, and between the animals themselves, is a pressing concern. Any number of microorganisms can be the source of disease in an AFO, including bacteria, viruses, parasites, insects, molds and fungi. In poultry coops and barns, pathogens causing diseases such as, for example, avian flu, coliform infections, respiratory diseases, cholera, enteritis, typhoid, and botulism, to name a few, can lead to entire flock loss if not addressed quickly and completely.

A common form of protection from bacterial diseases, which has been utilized in poultry and ruminant livestock husbandry alike, is routine preemptive antibiotic treatment. According to the Food and Drug Administration, as much as 80% of the antibiotics sold in the United States are being administered to farm animals. This practice poses a risk to the humans who eventually consume these animals. Perhaps more dangerous still, is that the overuse of these drugs increases the likelihood of epidemics of antibiotic resistant bacteria that could plague livestock and humans alike.

With poultry rearing, vaccination of chicks and separation of infected individuals can also be effective tools in preventing the spread of certain diseases between birds. However, pathogens in the air and litter of an unhygienic coop or barn can still wreak havoc on a flock. For poultry and waterfowl, molds, mold spores and fungi play a key role in bird loss. Following damp weather, and even after drying out damp coop conditions, molds that were once actively growing lose the dampness they need to survive. As a result, they form spores that are capable of surviving under the suboptimal conditions. The spores become airborne, or remain in the litter and dust on the ground only to be released into the air when the litter and dust are disturbed by rustling birds. When inhaled by the birds, the spores germinate in the lungs and trachea, creating upper respiratory fungal infections.

Ultimately, drugs, antibiotics or vaccines cannot permanently solve disease-related problems on a poultry farm or in hatcheries if the premises is not properly sanitized. Hygiene and sanitation play a major role in any effective disease control program for poultry production premises. One method for ensuring sanitary conditions is thermal fogging. Thermal fogging utilizes thermo-kinetic nebulization to rapidly atomize disinfectant solutions, creating a dense fog of ultra-fine particles (e.g., from 1-50 μm in size) that can fill the entire barn, contact airborne pathogens, decontaminate equipment, and disinfect surfaces. The fogging can be performed from one stationary location, for example, at the entrance to the barn. Once application is complete, the disinfectant fog remains suspended in the air for several hours, and then settles uniformly onto surfaces, and even in hard-to-reach cracks and crevices. In addition, fogging can be an economical solution for treating large spaces like poultry barns with a minimum quantity of active substance, meaning less operational requirements, quicker completion, and lower environmental residues.

Many poultry farmers perform a thermal fog as the final step in a hygiene protocol, once the equipment and floor insulation (often comprising straw or wood shavings) are reintroduced into the barn. This helps to address any pathogens that might be brought with the equipment and/or floor insulation. Ideally, the disinfectant fumes dissipate quickly to safe levels and the barn is reusable within hours, leading to faster turnaround between cleaning and introduction of the birds.

Any number of types and doses of disinfectant can be used in a thermal fogger. Ideally, the solution is low in toxicity and is environmentally-friendly. One traditional solution has comprised formalin, or aqueous solution of formaldehyde. However, this can produce dangerous fumes and can be carcinogenic at certain doses. Other solutions can comprise harsh solutions containing, for example, phenolic compounds, chlorine (e.g., bleach), iodine, ammonium, and/or oxidizing compounds.

A poultry site must be prepared methodically for the entry of each new batch of birds (e.g., removal of birds, litter and manure; pest control; sweeping and pressure washing; disinfection; fumigation). Hygiene and sanitation are crucial to a successful flock, and care should be exercised in the performance of sanitary procedures particularly after a disease outbreak. Immediate disposal of dead and diseased birds is an important and effective tool in preventing the dissemination of disease. Regular visual inspection, together with routine testing for deleterious microorganisms, ensures the efficacy of cleaning and disinfection.

When used correctly, thermal fogging is an important step in the care and hygiene of livestock animals. Thermal fogging after proper cleaning reaches areas not easily accessible through conventional scrubbing and power washing. At the same time, the small droplet sizes allow the fog to remain airborne for several hours, slowly depositing on surfaces inside the barn.

The amount of disinfectant needed for thermal fogging is advantageously low. Nonetheless, the use of harsh and potentially toxic disinfectants is still cause for concern due to the potential to cause harm to workers, animals and consumers. Thus, methods are needed for disinfecting animal feeding operations and controlling the spread of disease-causing pathogens that utilize safe, environmentally-friendly materials without compromising the health and vitality of livestock and humans.

### BRIEF SUMMARY OF THE INVENTION

The subject invention provides disinfectant compositions and methods of using these compositions for controlling disease in livestock production operations. Advantageously, the compositions and methods of the subject invention are safe, environmentally-friendly, and cost-effective means of enhancing livestock production.

In one embodiment, a composition is provided for controlling disease-causing pathogens in an animal enclosure, e.g., an AFO. The pathogens (e.g., bacteria, fungi, viruses, molds, spores, parasites and protozoa) might be present in the air, on surfaces, in animal waste, in an animal's lungs or airways, and/or on an animal (e.g., on skin, fur, feathers, feet or hooves).

In a specific embodiment, the composition is a microbe-based product comprising the cultivation by-products of a biochemical-producing microorganism. Preferably, the microorganism is a biosurfactant-producing yeast, such as, for example, Starmerella bombicola or Wickerhamomyces anomalus.

In preferred embodiments, the composition comprises one or more biosurfactants, such as glycolipids, lipopeptides, flavolipids, phospholipids, fatty acid esters, lipoproteins, lipopolysaccharide-protein complexes, and polysaccharide-protein-fatty acid complexes.

In one embodiment, the biosurfactants are glycolipids (e.g., sophorolipids, rhamnolipids, cellobiose lipids, mannosylerythritol lipids, and trehalose lipids), lipopeptides (e.g., surfactin, iturin, fengycin, and lichenysin), and/or phospholipids (e.g., cardiolipins). In a specific embodiment, the composition comprises sophorolipids, including acidic and/or lactonic form sophorolipids.

The composition can comprise the biosurfactants in purified form or crude form, where the crude form can comprise the fermentation broth in which the biosurfactants were produced. The microbes may be present in, or separated from, the fermentation broth. If present, the microbes may be active or inactive.

In one embodiment, the disinfectant composition can further comprise an aqueous carrier, such as water, a ketone, an oil, an aldehyde and/or an alcohol (e.g., ethanol or isopropyl alcohol). In one embodiment, the composition is supplied in the form of, for example, a liquid suspension, an emulsion, a freeze dried or spray dried powder, pellets, granules, gels, or a wettable powder. Preferably, when used according to the subject invention, the composition is in liquid form, which can be achieved by dissolving the composition in water if supplied in a dry form. In certain embodiments, the composition is diluted prior to use in order to achieve a desired concentration of active ingredients (e.g., the biosurfactants).

The disinfectant composition can also be prepared in combination with other ingredients such as organic solvents, salts, essential oils, fragrances, chelants, enzymes, acids (e.g., acetic acid), carbonates or bicarbonates, phosphates, wetting agents, dispersing agents, hydrotropes, rheology control agents, foam suppressants, corrosion inhibitors, pH adjusters, natural phenolic compounds (e.g., thymol or carcavrol), sequestering agents, fog promoting agents (e.g., monopropyleneglycol (MPG)), and other ingredients that serve a particular desired function.

In certain embodiments, the compositions have advantages over, for example, purified microbial metabolites alone, due to one or more of the following: high concentrations of mannoprotein as a part of a yeast cell wall's outer surface; the presence of beta-glucan, which is present in yeast cell walls; and the presence of biosurfactants and other metabolites and/or solvents in the culture (e.g., lactic acid, ethanol, etc.).

In one embodiment, methods are provided for controlling a disease-causing pathogen in an enclosure, the method comprising contacting a disinfectant composition of the subject invention with the pathogen. Preferably, the enclosure is a building or enclosure used for housing, feeding, and/or transporting livestock. Even more preferably, the enclosure is an AFO, such as a coop or barn used for producing poultry, waterfowl, or other avian species.

In some embodiments, the methods can be employed in barns, coops, stables, stalls, pens, or other livestock housing and feeding enclosures. In some embodiments, the methods can be employed in enclosures used to transport livestock, such as, for example, truck trailers. In some embodiments, the methods can be employed in slaughterhouses and meat packaging facilities.

The disinfectant formulation may be contacted with the pathogen by means of a variety of techniques, although preferably, the composition is administered inside an enclosure in the form of small airborne particles. For example, the composition can be applied using a diffuser, an aerosolizer, a mister, a nebulizer, an atomizer or a fogger. Preferably, the composition is applied inside the enclosure via thermal fogging so that the composition fills the air inside the entire enclosure (e.g., contacts the air and surfaces from floor to ceiling, and from wall to opposite wall), remains airborne for several hours and eventually settles onto the surfaces and floor inside the enclosure.

In one embodiment, the fogging serves as a supplement to a standard hygiene regimen employed by an animal caregiver. In one embodiment, all animals, equipment and floor litter are removed from the enclosure prior to implementing the method therein. In one embodiment, the equipment and floor litter are in the enclosure while implementing the method. Thus, the method can be used to disinfect the litter and equipment, as well as the air, floor and interior surfaces of the enclosure.

The animals may be present in or absent from the enclosure when fogging occurs. When present, the composition can disinfect not only the animals' environment, but can also disinfect pathogenic microorganisms present on the animals or, for example, in the animals' airways and lung tissue through inhalation of the composition. In certain embodiments, the methods also disinfect the animals' waste matter of a pathogenic microbe.

The subject invention can be used to enhance livestock production by protecting the animals from infection, infestation and/or diseases caused by deleterious single- or multi-cellular organisms, including but not limited to, bacteria, fungi, viruses, molds, spores, parasites and protozoa. For example, the subject invention can be used to protect poultry and other bird flocks from “bird flu,” or “avian influenza,” which can also infect humans.

Advantageously, the present invention can be used without releasing large quantities of inorganic compounds and without leaving behind harmful residues in the environment. Additionally, the compositions and methods utilize components that are biodegradable and toxicologically safe. Thus, the present invention can be used for enhancing livestock production as a “green” treatment.

### DETAILED DESCRIPTION OF THE INVENTION

The subject invention provides disinfectant compositions and methods of using these compositions for controlling disease in livestock production operations. Advantageously, the compositions and methods of the subject invention are safe, environmentally-friendly, and cost-effective means of enhancing livestock production.

In one embodiment a disinfectant composition is provided for controlling disease-causing pathogens in an enclosure, such as, e.g., an animal feeding operation (AFO). By contacting the composition with a pathogen (e.g., bacteria, fungi, viruses, molds, spores, parasites and/or protozoa) present in the air, on surfaces, in animal waste, in an animal's lungs or airways, and/or on an animal (e.g., on skin, fur, feathers, feet or hooves), the subject invention can be used to protect animals (and the humans who produce and consume them) from infection, infestation and/or disease caused by the pathogen.

### Selected Definitions

As used herein an “animal feeding operation,” or “AFO,” refers to a lot or facility (not including a fish farming facility) where animals have been, are, or will be stabled or confined and fed or maintained for a total of 45 days or more in any 12-month period, and crops, vegetation, forage growth, or post-harvest residues are not sustained in the normal growing season over any portion of the facility. AFOs essentially utilize man-made structures and equipment (for feeding, temperature controls, manure management, etc.) in the place of land and labor. A “CAFO,” or “concentrated AFO” is an AFO that concentrates large numbers of animals in relatively small and confined spaces, the size of which meet certain thresholds delineated by the Environmental Protection Agency.

As used herein, a “biofilm” is a complex aggregate of microorganisms, such as bacteria, wherein the cells adhere to each other and/or to a surface using an extracellular polysaccharide matrix. The cells in biofilms are physiologically distinct from planktonic cells of the same organism, which are single cells that can float or swim in liquid medium.

As used herein, the terms “disinfect” means to control an undesirable organism. “Control” as used in reference to the activity of a disinfectant composition extends to the act of killing, disabling, immobilizing, or reducing population numbers of an organism, or otherwise rendering the organism substantially incapable of causing disease. With regard to a biofilm, control can further refer to disrupting the formation of biofilms, and/or dismantling an existing biofilm. In specific embodiments, the organisms are pathogenic. In some embodiments, disinfect means to control at least 85% of undesirable organisms in the area being treated, preferably at least 95%, more preferably at least 99%.

As used herein, “harvested” refers to removing some or all of a microbe-based composition from a growth vessel.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. A purified or isolated microbial strain means that the strain is removed from the environment in which it exists in nature. Thus, the isolated strain may exist as, for example, a biologically pure culture, or as spores (or other forms of the strain) in association with a carrier.

As used here in, a “biologically pure culture” is one that has been isolated from materials with which it is associated in nature. In a preferred embodiment, the culture has been isolated from all other living cells. In further preferred embodiments, the biologically pure culture has advantages characteristics compared to a culture of the same microbe as it exists in nature. The advantages characteristics can be, for example, enhanced production of one or more growth by-products.

In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

As used herein, “livestock” refers to any domesticated animal raised in an agricultural or industrial setting to produce commodities such as food, fiber and labor. “Livestock production” includes the breeding, raising, rearing, husbandry, maintenance, transportation and/or slaughter of these animals. Livestock can be produced free-range, such as on open fields, on farms, or in animal feeding operations. Types of animals that are considered livestock include, but are not limited to, alpacas, beef and dairy cattle, bison, pigs, sheep, goats, horses, mules, asses, dogs, camels, chickens, turkeys, ducks, geese, swans, quail, guinea fowl, partridges, pheasants, grouses, peacocks, pigeons, and squabs.

A “metabolite” refers to any substance produced by metabolism (e.g., a growth by-product) or a substance necessary for taking part in a particular metabolic process. A metabolite can be an organic compound that is a starting material, an intermediate in, or an end product of metabolism. Examples of metabolites include, but are not limited to, biopolymers, enzymes, acids, solvents, alcohols, proteins, vitamins, minerals, microelements, amino acids, and biosurfactants.

As used herein, reference to a “microbe-based composition” means a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of microbial propagule, or a mixture of these. The microbes may be planktonic or in a biofilm form, or a mixture of both. The by-products of growth may be, for example, metabolites (e.g., biosurfactants), cell membrane components, proteins, and/or other cellular components. The microbes may be intact or lysed. The cells may be absent, or present at, for example, a concentration of at least 1×10⁴, 1×10⁵, 1×10⁶, 1×10⁷, 1×10⁸, 1×10⁹, 1×10¹⁰, 1×10¹¹, 1×10¹², 1×10¹³ or more CFU/ml of the composition.

The subject invention further provides “microbe-based products,” which are products that are to be applied in practice to achieve a desired result. The microbe-based product can be simply the microbe-based composition harvested from the microbe cultivation process. Alternatively, the microbe-based product may comprise further ingredients that have been added. These additional ingredients can include, for example, stabilizers, buffers, appropriate carriers, such as water or salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein, a “pathogenic” organism is any organism that is capable of causing a disease in another organism. Typically, pathogenic organisms are infectious agents and can include, for example, bacteria, viruses, fungi, molds, protozoa, prions, parasites, helminths, and algae.

As used herein, a “pest” is any organism, other than a human, that is destructive, deleterious and/or detrimental to humans or human concerns (e.g., agriculture, horticulture, livestock production, aquaculture). In some, but not all instances, a pest may be a pathogenic organism. Pests may cause and/or carry infections, infestations and/or disease, or they may simply feed on or cause other physical harm to living tissue. Pests may be single- or multi-cellular organisms, including but not limited to, viruses, fungi, bacteria, protozoa, parasites, and/or nematodes.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduces” refers to a negative alteration, and “increases” refers to a positive alteration, of at least 1%, 5%, 10%, 25%, 50%, 75%, or 100%

As used herein, “reference” refers to a standard or control condition.

As used herein, “surfactant” refers to a compound that lowers the surface tension (or interfacial tension) between a liquid and a gas, between two liquids or between a liquid and a solid. Surfactants act as, e.g., detergents, wetting agents, emulsifiers, flaming agents, and dispersants. A “biosurfactant” is a surfactant produced by a living organism.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially” of the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Disinfectant Compositions

The subject invention provides disinfectant compositions comprising beneficial microorganisms and/or by-products of their growth, such as biosurfactants. The subject invention also provides methods of using these compositions in enhancing livestock production. Furthermore, the subject invention provides materials and methods for producing the microbe-based compositions.

Advantageously, the microbe-based compositions produced according to the subject invention are non-toxic (e.g., ingestion toxicity is greater than 5 g/kg of body weight) and can be applied in high concentrations without causing irritation to, for example, a human or animal's epidermis, respiratory tract or digestive tract. Thus, the subject invention is particularly useful where application of the microbe-based compositions occurs in the presence of livestock produced by humans and for human consumption, e.g., when used for controlling disease-causing pathogens in an animal feeding operation (AFO).

In a specific embodiment, the composition is a microbe-based product comprising the cultivation by-products of a biochemical-producing microorganism. Preferably, the microbes of the subject invention are non-pathogenic biosurfactant-producing yeasts, such as, for example, Starmerella bombicola or Wickerhamomyces anomalus. These yeasts are effective producers of glycolipid biosurfactants.

In one embodiment, the composition comprises biosurfactants. Safe, effective microbial biosurfactants reduce the surface and interfacial tensions between the molecules of liquids, solids, and gases. Additionally, many biosurfactants have antifungal, antibacterial, anti-parasitic and/or antiviral properties. Biosurfactants inhibit microbial adhesion to a variety of surfaces, prevent the formation of biofilms, and can have powerful emulsifying and demulsifying properties.

Biosurfactants are biodegradable and can be efficiently produced using selected organisms on renewable substrates. Most biosurfactant-producing organisms produce biosurfactants in response to the presence of a hydrocarbon source (e.g. oils, sugar, glycerol, etc.) in the growing media. Other media components such as concentration of iron can also affect biosurfactant production significantly.

Biosurfactants according to the subject invention include, for example, glycolipids, lipopeptides, flavolipids, phospholipids, fatty acid esters, lipoproteins, lipopolysaccharide-protein complexes, and polysaccharide-protein-fatty acid complexes.

In one embodiment, the composition comprises one or more biosurfactants selected from glycolipids (e.g., sophorolipids, rhamnolipids, mannosylerythritol lipids, cellobiose lipids, and trehalose lipids) and lipopeptides (e.g., surfactin, iturin, fengycin, arthrofactin and lichenysin). In a specific embodiment, the composition comprises sophorolipids, including acidic and/or lactonic forms of sophorolipids.

In certain embodiments, the concentration of the one or more biosurfactants in the disinfectant composition is about 0.001 to 90 by weight % (wt %), about 0.01 to 50 wt %, or about 0.1 to 20 wt %. In certain embodiments, the biosurfactants are present at about 0.01 g/L to about 500 g/L, about 0.5 g/L to about 50.0 g/L, about 1.0 to about 10.0 g/L, or about 2.0 to about 5.0 g/L.

The composition can comprise the biosurfactants in purified form or crude form, where the crude form can comprise the fermentation broth in which the biosurfactants were produced. In one embodiment, crude form biosurfactants can be used, wherein the crude form comprises a liquid mixture comprising biosurfactant precipitate in fermentation broth resulting from cultivation of a biosurfactant-producing microbe. This crude form biosurfactant solution can comprise from about 0.001% to about 99%, from about 25% to about 75%, from about 30% to about 70%, from about 35% to about 65%, from about 40% to about 60%, from about 45% to about 55%, or about 50% biosurfactant wt %.

In certain embodiments, the microbe-based composition of the subject invention can comprise the fermentation broth containing a live and/or an inactive culture and/or the microbial metabolites produced by the microorganism and/or any residual nutrients. The product of fermentation may be used directly without extraction or purification. If desired, extraction and purification can be easily achieved using standard extraction and/or purification methods or techniques described in the literature.

The composition may be, for example, at least, by weight, 1%, 5%, 10%, 25%, 50%, 75%, or 100% growth medium. The amount of biomass in the composition, by weight, may be, for example, anywhere from 0% to 100% inclusive of all percentages therebetween, for example from 5 g/l to 180 g/l or more, or from 10 g/l to 150 g/l.

In certain embodiments, the compositions have advantages over, for example, purified microbial metabolites alone, due to one or more of the following: high concentrations of mannoprotein as a part of a yeast cell wall's outer surface; the presence of beta-glucan, which is present in yeast cell walls; and the presence of biosurfactants and other metabolites and/or solvents in the culture (e.g., lactic acid, ethanol, etc.).

In one embodiment, the disinfectant composition can further comprise a carrier, such as water, a ketone, an oil (e.g., mineral oil or vegetable oil), an oil/water emulsion, an aldehyde and/or an alcohol (e.g., ethanol or isopropyl alcohol). The carrier can comprise about 1% to about 99%, about 5% to 95%, about 10% to 90%, or preferably about 50% to 80% of the final composition.

In one embodiment, the composition is supplied in the form of, for example, a liquid suspension, an emulsion, a freeze dried or spray dried powder, pellets, granules, gels, or a wettable powder. Preferably, when used according to the subject invention, the composition is in liquid form, which can be prepared by dissolving the composition in water or another solvent or carrier. In certain embodiments, the composition is diluted prior to use in order to achieve a desired concentration of active ingredients (e.g., the biosurfactants).

In one embodiment, the composition comprises one or more essential oils having one or more beneficial properties, including anti-pathogenicity and/or pest deterrence. Essential oils can be selected from, for example, oregano, lavender, tea tree, frankincense, peppermint, lemon or other citrus, rosemary, thyme, cinnamon, eucalyptus, clove, lemongrass, citronella, cedarwood, nutmeg, neem, and others. Preferably, the essential oil comprises from 0.5% to 10% (v/v), or 1% to 5% of the final composition.

In certain embodiments, the disinfectant composition can comprise a fog promoter. Preferably, the fog promotor is a non-toxic glycol- or glycerol-based substance, such as, for example, glycerin, monopropyleneglycol (MPG) or dipropyleneglycol. For example, the fog promoter can comprise about 5% to 20% of the final composition.

The disinfectant composition can also be prepared in combination with other ingredients such as organic solvents, salts, fragrances, chelants, enzymes, acids (e.g., acetic acid), carbonates or bicarbonates, phosphates, wetting agents, dispersing agents, hydrotropes, rheology control agents, foam suppressants, corrosion inhibitors, pH adjusters, natural phenolic compounds (e.g., thymol or carcavrol), sequestering agents, and other ingredients that serve a particular desired function.

The concentrations of any component of the disinfectant composition can vary depending on the desired effect of the formulation and/or the exact mode of application. In non-limiting embodiments, for example, the formulations may include in their final form, for example, at least about 0.0001%, 0.0005%, 0.001%, 0.01%, 0.05%, 0.1%, 0.5%, 1.0%, 5.0%, 10%, 20%, 25%, 50%, 75%, 90%, 95%, or 99% or more, or any range or integer derivable therein, of at least one of the ingredients mentioned throughout the specification and/or claims. In non-limiting aspects, the percentage can be calculated by weight or volume of the total composition.

### Growth of Microbes According to the Subject Invention

The subject invention utilizes methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

As used herein “fermentation” refers to cultivation or growth of cells under controlled conditions. The growth could be aerobic or anaerobic.

In one embodiment, the subject invention provides materials and methods for the production of biomass (e.g., viable cellular material), extracellular metabolites (e.g. small molecules and proteins), residual nutrients and/or intracellular components (e.g. enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In preferred embodiments, a microbe growth facility comprising multiple microbe growth vessels produces fresh, high-density microorganisms and/or microbial growth by-products of interest on a desired scale. The microbe growth facility may be located at or near the site of application. The facility produces high-density microbe-based compositions in batch, quasi-continuous, or continuous cultivation.

The distributed microbe growth facilities can be located at the location where the microbe-based product will be used (e.g., a chicken farm). For example, the microbe growth facility may be less than 300, 250, 200, 150, 100, 75, 50, 25, 15, 10, 5, 3, or 1 mile from the location of use, or can be located directly on the site of use.

In certain embodiments, production may or may not be achieved using local and/or distributed fermentation methods, meaning that conventional methods can also be utilized according to the subject invention. However, local and/or distributed microbe growth facilities as described herein advantageously provide a solution to the current problem of relying on far-flung industrial-sized producers whose product quality suffers due to upstream processing delays, supply chain bottlenecks, improper storage, and other contingencies that inhibit the timely delivery and application of a useful product.

The microbe growth facilities produce fresh, microbe-based compositions, comprising the microbes themselves, microbial metabolites, and/or other components of the broth in which the microbes are grown. If desired, the compositions can have a high density of vegetative cells, inactive cells, propagules, or a mixture of vegetative cells, inactive cells and/or propagules.

Advantageously, the compositions can be tailored for use at a specified location. In one embodiment, the microbe growth facility is located on, or near, a site where the microbe-based products will be used. The microbe growth facilities may operate off the grid by utilizing, for example, solar, wind, and/or hydroelectric power.

The microbe growth facilities provide manufacturing versatility by the ability to tailor the microbe-based products to improve synergies with destination geographies. For example, the systems of the subject invention are capable of harnessing the power of naturally-occurring local microorganisms and their metabolic by-products. Local microbes can be identified based on, for example, salt tolerance, ability to grow at high temperatures, and/or ability to produce certain metabolites.

Because the microbe-based product is generated on-site or near the site of application, without the requirement of stabilization, preservation, prolonged storage and extensive transportation processes of conventional production, a much higher density of live (or inactive) microorganisms and/or propagules thereof can be generated, thereby requiring a much smaller volume of the microbe-based product for use in an on-site application or allowing for much higher density of microbial applications where necessary. This reduces the possibility of contamination from foreign agents and undesirable microorganisms, maintains the activity of the by-products of microbial growth, and allows for an efficient scaled-down bioreactor (e.g. smaller fermentation tank and smaller volume of starter materials, nutrients, pH control agents, and de-foaming agent, etc.), with no reason to stabilize the cells. Locally-produced high density, robust cultures of microbes are more effective in the field than those that have undergone vegetative cell stabilization or have been sitting in the supply chain for some time.

Local generation of the microbe-based product also facilitates the inclusion of the fermentation broth in the product. The broth can contain agents produced during the fermentation that are particularly well-suited for local use. This further facilitates the portability of the product and reduces transportation times.

In one embodiment, the method of cultivation, whether performed using conventional methods or using local or distributed systems, can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can further comprise supplementing the cultivation with a carbon source. The carbon source can be a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials to the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods known in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

In the case of submerged fermentation, the biomass content of the fermentation broth may be, for example, from 5 g/l to 180 g/l, or from 10 g/l to 150 g/l.

In the case of a dried product, or a product of solid state fermentation or modified versions thereof, the cell concentration may be, for example, 1×10⁹, 1×10¹⁰, 1×10¹¹, 1×10¹² or 1×10¹³ CFU per gram of final product.

The microbial growth by-product produced by microorganisms of interest may be retained in the microorganisms or secreted into the growth medium. The medium may contain compounds that stabilize the activity of microbial growth by-product.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

Advantageously, the microbe-based products can be produced in remote locations. The microbe growth facilities may operate off the grid by utilizing, for example, solar, wind and/or hydroelectric power.

### Microbial Strains

The microorganisms useful according to the subject invention can be, for example, non-pathogenic strains of bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In one embodiment, the microorganism is a yeast or fungus. Yeast and fungus species suitable for use according to the current invention, include Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffii), Lentinula edodes, Mortierella, Mycorrhiza, Meyerozyma (e.g., M. guilliermondii), Penicillium, Phycomyces, Pichia (e.g., P. anomala, P. guilliermondii, P. occidentalis, P. kudriavzevii), Pleurotus (e.g., P. ostreatus) Pseudozyma (e.g., P. aphidis), Saccharomyces (e.g., S. boulardii sequela, S. cerevisiae, S. torula), Starmerella (e.g., S. bombicola), Trichoderma (e.g., T reesei, T. harzianum, T. hamatum, T. viride), Torulopsis, Ustilago (e.g., U. maydis), Wickerhamomyces (e.g., W. anomalus), Williopsis (e.g., W. mrakii), Zygosaccharomyces (e.g., Z. bailii), and others.

In one embodiment, the microorganism is a biosurfactant-producing yeast. For example, in one embodiment, the microorganism is Starmerella bombicola, which is an efficient producer of sophorolipid biosurfactants.

In one embodiment, the yeast is Wickerhamomyces anomalus (Pichia anomala). Other closely related species are also envisioned, e.g., other members of the Wickerhamomyces and/or Pichia clades.

W. anomalus have a number of beneficial characteristics useful for the present invention, including their ability to produce advantageous metabolites. For example, W. anomalus is capable of exo-β-1,3-glucanase activity, making it capable of controlling or inhibiting the growth of a wide spectrum of pathogenic fungi. Additionally, W. anomalus produces phospholipid biosurfactants.

In certain embodiments, the microorganisms are non-pathogenic bacteria, including Gram-positive and Gram-negative bacteria. The bacteria may be, for example Agrobacterium (e.g., A. radiobacter), Azotobacter (A. vinelandii, A. chroococcum), Azospirillum (e.g., A. brasiliensis), Bacillus (e.g., B. amyloliquifaciens, B. firmus, B. laterosporus, B. licheniformis, B. megaterium, Bacillus mucilaginosus, B. subtilis), Frateuria (e.g., F. aurantia), Microbacterium (e.g., M. laevaniformans), Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), and/or Sphingomonas (e.g., S. paucimobilis).

Other microbial strains including, for example, strains capable of accumulating significant amounts of, for example, biosurfactants, can be used in accordance with the subject invention. Other microbial by-products useful according to the present invention include mannoprotein, beta-glucan and other metabolites that have bio-emulsifying and surface/interfacial tension-reducing properties.

### Preparation of Microbe-Based Products

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, the different strains of microbe are grown separately and then mixed together to produce the microbe-based product. The microbes can, optionally, be blended with the medium in which they are grown and dried prior to mixing.

In one embodiment, a yeast fermentation product is obtained via cultivation of a biosurfactant-producing and/or metabolite-producing yeast, such as, for example, Pichia anomala (Wickerhamomyces anomalus). The fermentation broth after 7 days of cultivation at 25-30° C. can contain the yeast cell suspension and, for example, 4 g/L or more of biosurfactant.

The yeast fermentation product can also be obtained via cultivation of a biosurfactant-producing yeast, such as, for example, Starmerella bombicola. The fermentation broth after 5 days of cultivation at 25° C. can contain the yeast cell suspension and, for example, 150 g/L or more of biosurfactant.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, stabilizers, ultra-violet light resistant agents, essential oils, other microbes and other suitable additives that are customarily used for such preparations.

In one embodiment, the composition may further comprise buffering agents including organic and amino acids or their salts. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In a further embodiment, pH adjusting agents include potassium hydroxide, ammonium hydroxide, potassium carbonate or bicarbonate, hydrochloric acid, nitric acid, sulfuric acid or a mixture.

In one embodiment, additional components such as an aqueous preparation of a salt such as sodium bicarbonate or carbonate, sodium sulfate, sodium phosphate, sodium biphosphate, can be included in the formulation.

In one embodiment fog promoters are added to the composition in order to produce fog with a desired particle size and dispersal time. Glycerol and/or glycol-based substances as described elsewhere herein can be used to this end.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

### Methods of Controlling Pathogens in Livestock Production Facilities

In one embodiment, methods are provided for controlling a disease-causing pathogen in an enclosure, which comprises contacting a disinfectant composition of the subject invention with the pathogen. Preferably, the enclosure is a building or enclosure used for housing, feeding, and/or transporting livestock. Even more preferably, the enclosure is an AFO, such as a coop or barn used for producing poultry, waterfowl, or other avian species.

In some embodiments, the methods can be employed in barns, coops, stables, stalls, pens, or other livestock housing and feeding enclosures. In some embodiments, the methods can be employed in enclosures used to transport livestock, such as, for example, truck trailers. In some embodiments, the methods can be employed in slaughterhouses and meat packaging facilities.

The subject invention can be used to enhance livestock production by protecting the animals from infection, infestation and/or diseases caused by deleterious single- or multi-cellular organisms, including but not limited to, bacteria, fungi, viruses, molds, spores, parasites and protozoa. For example, the subject invention can be used to protect poultry and other bird flocks from “bird flu,” or “avian influenza,” which can also infect humans.

As used herein, “applying” a composition or product, or “treating” an environment refers to contacting a composition or product with a target or site such that the composition or product can have an effect on that target or site. The effect can be due to, for example, microbial growth and/or the action of a metabolite, enzyme, biosurfactant or other microbial growth by-product.

The disinfectant formulation may be contacted with the pathogen by means of a variety of techniques, although preferably, the composition is administered inside an enclosure using a form of fogging. In one embodiment, the composition is applied using a diffuser, an aerosolizer, a mister, a nebulizer, an atomizer or a fogger.

Preferably, the composition is applied inside the enclosure via thermal fogging so that the composition fills the entire enclosure, remaining airborne for several hours and eventually settling onto the surfaces and floor inside the enclosure.

In certain embodiments, the subject invention utilizes a thermal fogger to apply the disinfectant composition. A thermal fogger is used to create aerosols by combining a hot stream of gas or a heat source and a stream of liquid treatment chemical in an aerosolization chamber. The disinfectant solution is drawn from a tank into the aerosolization chamber and flash evaporated by being heated with a hot blast of air and then forced through a nozzle. The hot air burns or consumes solvents and spreads a thin dry mist and fog into the air, covering a large area quickly. The resulting aerosol particles are suspended within the air for a period of time in order to disinfect both the air itself and surfaces, including inaccessible parts of a structure, such as air vents. The aerosolized particles can have a particle size of from about 1 μm to about 200 μm, preferably from about 10 μm to about 150 μm, even more preferably less than 100 μm.

Fogging offers a number of advantages over simply spraying the interior of an enclosure. For example, spraying can produce only about 200-300 million droplets from a quart of solution, whereas fogging machines can break up a solution to, for example, billions of particles per quart. Additionally, small particles not only make fogging more efficient than spraying, but also more effective. Because the particles are so small they remain airborne for longer periods of time, and air currents carry them throughout the entirety of the space of an indoor environment (e.g., from floor to ceiling, and from wall to opposite watll). The fog migrates into cracks and crevices and makes contact with pathogens present in hard-to-reach locations. Furthermore, the fog is a dry fog rather than a wet treatment, and leaves behind no residue.

In certain embodiments, the composition of the subject invention can be mixed with, for example, water and if desired, a fog promoter and/or other additives (e.g., essential oils), and then loaded into the tank of a thermal fogging machine. The fogging machine can be operated at a flow rate of, for example 1 L/minute for at least 30 minutes. The timing can be determined based on, for example, the size of the enclosure. Once the enclosure is filled with the fog, it can be left for a certain period of time to allow an even dispersal throughout the entire space. The enclosure can then be ventilated for as long as it takes for the fog to dissipate visually.

In one embodiment, a treatment dosage for an enclosure will be determined based on the cubic volume of the enclosure. In one exemplary embodiment, approximately 5 to 25 L, or about 10 to 20 L of a 1 to 15% or 5 to 10% biosurfactant solution, or less, can be used to treat about 750 to 1,500 m³, or about 1,000 m³ of enclosed space.

In one embodiment, the fogging serves as a supplement to a standard hygiene regimen employed by an animal caregiver. In one embodiment, all animals, equipment and floor litter are removed from the enclosure prior to implementing the method therein. In one embodiment, the equipment and floor litter are in the enclosure while implementing the method. Thus, method can be used to disinfect the litter and equipment, as well as the air, floor and interior surfaces of the enclosure.

The animals may be present in or absent from the enclosure when fogging occurs. When present, the composition can disinfect not only the animals' environment, but can also disinfect pathogenic microorganisms present on the animals or, for example, in the animals' airways and lung tissue through inhalation of the composition. In certain embodiments, the method also disinfect an animal's waste matter.

### Target Pathogens

In some embodiments, microbe-based products and methods are provided for prevention and/or treatment of infection or infestation by deleterious single- or multi-cellular organisms and/or enhancing growth and health of livestock. Advantageously, the methods can enhance livestock production without use of harsh chemicals or antibiotics.

Pathogens against which the subject methods and compositions are useful include those affecting livestock animals such as, e.g., alpacas, beef and dairy cattle, bison, pigs, dogs, sheep, goats, horses, mules, asses, camels, chickens, turkeys, ducks, geese, swans, quail, guinea fowl, partridges, pheasants, grouses, peacocks, pigeons, and squabs. In particularly preferred embodiments, the livestock are avian (bird) species.

Pathogens according the subject invention can be any infectious agent including, for example, bacteria, viruses, fungi, molds, protozoa, prions, parasites, helminths, and algae. These can include, and/or include those that cause, for example, Avian Encephalomyelitis, Avian Influenza, Avian Tuberculosis, Chicken Anaemia Virus Infection (CAV), Chlamydiosis, Egg Drop Syndrome (EDS), fowl cholera (Pasteurellosis), fowl pox, Infectious Bursal Disease (Gumboro), Infectious Coryza, Infectious Laryngotracheitis, Lymphoid Leukosis, Marek's Disease, Mycoplasmosis, necrotic enteritis, Newcastle Disease, Salmonellosis, Coccidiosis, Cryptosporidiosis, Histomoniasis, Toxoplasmosis, Trichomoniasis, Escherichia coli, infection bronchitis, Riemerella anatipestifer, cholangiohepatitis, gangrenous dermatitis, avian tuberculosis, haemorrhagic enteritis, adenovirus, swollen head syndrome, fowl typhoid, infectious encephalomyelitis, reovirus, erythroblastosis, adenocarcinomatosis, ascaridiosis, raillietinosis, knemidokoptosis, Aspergillosis, Aspergillus granulomatous dermatitis, aflatoxicosis, fusariotoxicoses, lice and mites.

Further examples of pathogens according to the subject invention include, and/or include those that cause, ringworm, Bovine Respiratory Disease Complex, blackleg (Clostridia), Bovine Respiratory Syncytial Virus, Bovine Viral Diarrhea, Haemophilus somnus, Infectious Bovine Rhinotracheitis, Pasteurella haemolytica and Pasteurella multocida, rabies, influenza, Colibacillosis, Bordetellosis, Mycoplasmas, Easter equine encephalitis, botulism, hemorrhagic enteritis, Salmonella, ulcerative or necrotic enteritis, pullorum disease, Coccidia, worms (e.g., roundworm, whipworm, kidney worm), blackhead, Staphylococcus, Streptococcus, parvovirus, Leptospirosis, Campylobacter, Trichinella, Toxoplasma, Listeria, MRSA, Pasteurella, Actinobacillus pleuropneumoniae, Brachyspira hyodsenteriae and many others.

1. A disinfectant composition comprising a biosurfactant-producing yeast and/or bacteria and/or a growth by-product thereof, a carrier and, optionally, a fog promoter.

2. (canceled)

3. The composition of claim 2, wherein the yeast is Starmerella bombicola or Wickerhamomyces anomalus and wherein the bacteria is Bacillus subtilis or Bacillus amyloliquefaciens.

4. (canceled)

5. The composition of claim 1, comprising fermentation broth in which the yeast and/or bacteria were grown.

6-9. (canceled)

10. The composition of claim 7, wherein the biosurfactant is a glycolipid, lipopeptide, fatty acid ester or phospholipid.

11. The composition of claim 10, wherein the biosurfactant is a sophorolipid and said sophorolipid is present in the composition at a concentration of 0.1% to 0.5%.

12. The composition of claim 1, wherein the carrier is water and/or an alcohol.

13. The composition of claim 1, comprising a fog promoter that is a glycerol- or glycol-containing substance.

14. (canceled)

15. A method for controlling a pathogen in an enclosure, the method comprising contacting the pathogen with a composition of claim 1.

16. The method of claim 15, wherein the enclosure is used for housing, feeding and/or transporting livestock.

17-18. (canceled)

19. The method of claim 16, wherein the enclosure is a coop or barn used for producing poultry, waterfowl or other birds, or wherein the enclosure is a trailer used for transporting livestock.

20. (canceled)

21. The method of claim 15, wherein the enclosure is a slaughterhouse or a meat packaging facility.

22. The method of claim 15, wherein the composition is applied inside the enclosure using a thermal fogger.

23. The method of claim 22, wherein the carrier is water and/or an alcohol.

24. The method of claim 22, wherein the fog promoter is a glycerol- or glycol-containing substance.

25-26. (canceled)

27. The method of claim 15, wherein the yeast is Starmerella bombicola or Wickerhamomyces anomalus and wherein the bacteria is Bacillus subtilis or Bacillus amyloliquefaciens.

28. (canceled)

29. The method of claim 15, wherein the composition comprises fermentation broth in which the yeast and/or bacteria were grown.

30-33. (canceled)

34. The method of claim 15, wherein the biosurfactant is a glycolipid, lipopeptide, fatty acid ester, or phospholipid.

35. The method of claim 34, wherein the biosurfactant is a sophorolipid and said sophorolipid is present in the composition at a concentration of 0.1% to 0.5%.

36-37. (canceled)
